(19) United States
(12) Patent Application Publication
(10) Pub. No.: US 2026/0214412 A1
(43) Pub. Date: Jul. 23, 2026

(54) DYNAMIC MOBILE GEOFENCING

(71) Applicants: Mikhail Damiani, New York, NY (US); Matthew Shay, New York, NY (US); Christian Georgeou, New York, NY (US); BLUE BITE LLC, New York, NY (US)

(72) Inventors: Mikhail Damiani, Surfside, FL (US); Matthew Shay, North Hills, NY (US); Christian Georgeou, New York, NY (US)

(21) Appl. No.: 19/144,417

(22) PCT Filed: Dec. 29, 2023
(86) PCT No.: PCT/US2023/086451

§ 371 Date: Jun. 27, 2025

Related U.S. Application Data
(60) Provisional application No. 63/436,454, filed on Dec. 30, 2022.

(51) Int. Cl. H04W 4/021; H04L 67/52; H04W 4/029

(52) U.S. Cl. CPC H04W 4/022; H04L 67/52; H04W 4/029

(57) ABSTRACT

A method includes receiving location data for a movable object, the location data specifying geographic locations of the movable object over time; defining dimensions of a virtual boundary in real-world physical space based on the geographic locations of the movable object over time and configuration parameters for the virtual boundary; sending data indicative of the virtual boundary in real-world physical space to trigger delivery of content to mobile computing devices within the virtual boundary; and actively adjusting the configuration parameters for the virtual boundary in response to a number of the mobile computing devices within a region while continuing to receive the location data for the movable object, define the dimensions of the virtual boundary, and send the virtual boundary to trigger delivery of content.

### CROSS-REFERENCE TO RELATED APPLICATION

This application claims priority to U.S. Provisional Application No. 63/436,454, filed Dec. 30, 2022, the entirety of which is incorporated herein by reference.

### FIELD OF THE DISCLOSURE

Technologies are described for allocating data based on real-time geolocation.

### BACKGROUND

In online communication campaigns, content may be provided to one or more targeted groups. For example, a user may be targeted to receive content based on the user's presence in a particular city or commercial establishment.

### SUMMARY

Some aspects of this disclosure describe a system. The system includes one or more processors, and one or more computer-readable mediums encoding instructions. The instructions, when executed, cause the one or more processors to: receive location data for a movable object, the location data specifying geographic locations of the movable object over time; define dimensions of a virtual boundary in real-world physical space based on the geographic locations of the movable object over time and configuration parameters for the virtual boundary; send data indicative of the virtual boundary in real-world physical space to trigger delivery of content to mobile computing devices within the virtual boundary; and actively adjust the configuration parameters for the virtual boundary in response to a number of the mobile computing devices within a region while continuing to receive the location data for the movable object, define the dimensions of the virtual boundary, and send the virtual boundary to trigger delivery of content.

This and other systems described herein can have one or more of at least the following characteristics.

In some implementations, the virtual boundary includes a first portion defining a region surrounding a current geographic location of the movable object, and a second portion that does not surround the current geographical location of the movable object. The configuration parameters include a dimension of the first portion.

In some implementations, the second portion defines a tail region surrounding a prior geographic location of the movable object at a prior time. The configuration parameters define at least one of a time interval between the prior time and a current time or a distance between the prior geographic location and the current geographic location.

In some implementations, the instructions, when executed, cause the one or more processors to actively adjust the configuration parameters in response to a speed of the movable object.

In some implementations, the active adjustment of the configuration parameters by the one or more processors in response to the speed of the movable object includes, in response to a decrease in the speed of the movable object, increasing a dimension of a region bounded by the virtual boundary.

In some implementations, the region includes a region bounded by the virtual boundary.

In some implementations, the active adjustment of the configuration parameters by the one or more processors in response to the number of the mobile computing devices within the region includes, in response to an increase in the number of the mobile computing devices within the region, decreasing a dimension of a region bounded by the virtual boundary.

In some implementations, the instructions, when executed, cause the one or more processors to obtain the location data periodically in accordance with a time interval. The active adjustment of the configuration parameters by the one or more processors in response to the number of the mobile computing devices within the virtual boundary includes, in response to an increase in the number of the mobile computing devices within the region, decreasing the time interval at which to send the virtual boundary to trigger delivery of content.

In some implementations, the instructions, when executed, cause the one or more processors to receive data indicative of a number of mobile computing devices engaging with the content, and determine the number of the mobile computing devices within the region based on the number of mobile computing devices engaging with the content.

In some implementations, the data indicative of the number of mobile computing devices engaging with the content includes a number of mobile computing devices that interact with a tracking pixel or a cookie associated with the content.

In some implementations, the active adjustment of the configuration parameters by the one or more processors in response to the number of the mobile computing devices within the region includes adjusting a dimension of a region bounded by the virtual boundary to cause a number of devices within the virtual boundary to match a target value.

In some implementations, the instructions, when executed, cause the one or more processors to determine the target value based on one or more of a remaining amount of the content for distribution, a remaining time for distribution of the content, or user engagement with previously-distributed content.

In some implementations, the instructions, when executed, cause the one or more processors to actively adjust a height of a region bounded by the virtual boundary.

In some implementations, the region bounded by the virtual boundary excludes a ground level in a vicinity of the movable object.

In some implementations, the active adjustment of the configuration parameters by the one or more processors in response to the number of the mobile computing devices within the region includes adjusting a shape of the virtual boundary to match a shape of a geographic feature.

In some implementations, the instructions, when executed, cause the one or more processors to determine the number of the mobile computing devices within the region based on one or more of traffic data or weather data.

In some implementations, the instructions, when executed, cause the one or more processors to actively adjust content presented by the movable object, and sending the data indicative of the virtual boundary in real-world physical space includes sending an indicator of particular content to deliver to the mobile computing devices within the virtual boundary. The particular content is associated with the content presented by the movable object.

In some implementations, actively adjusting the content presented by the movable device includes selecting the content presented by the movable object based on at least one of a location of the movable object, a current time, a surrounding environment of the movable object, or engagement data.

In some implementations, sending the data indicative of the virtual boundary in real-world physical space includes selecting particular content to deliver to the mobile computing devices within the virtual boundary based on dynamic content currently presented by the movable object; and sending an indicator of the particular content to trigger delivery of the particular content.

Some aspects of this disclosure describe a system for delivering content to mobile devices based on the mobile devices'locations relative to a movable object. The system includes a geofencing platform configured to receive location data for the movable object and to define a virtual boundary around the movable object based on a number of mobile devices in a region, the virtual boundary including a first portion surrounding a current location of the movable object and a second portion surrounding one or more prior locations of the movable object; a second platform configured to receive location data for the movable object; and a third platform configured to receive data indicative of the virtual boundary and to deliver content to mobile devices within the virtual boundary. The geofencing platform is configured to apply a machine learning model, the machine learning model configured to receive input data, and to determine, based on the input data, one or more configuration parameters for the virtual boundary, the configuration parameters including at least one of a particular dimension of the virtual boundary, a tail length of the virtual boundary, or a shape of the virtual boundary.

Some aspects of this disclosure describe another system for delivering content to mobile devices based on the mobile devices'locations relative to a movable object. The system includes a geofencing platform configured to receive location data for the movable object and to define a virtual boundary around the movable object, the virtual boundary including a first portion surrounding a current location of the movable object and a second portion surrounding one or more prior locations of the movable object. The second portion is associated with a tail length, and the virtual boundary has one or more particular dimensions and a shape, the one or more particular dimensions including at least one of a radius, width, length, or height, the shape including at least one of a circle, corridor, rectangle, ellipsis, star, oval, or polygon. The system includes a second platform configured to receive location data for the movable object; and a third platform configured to receive data indicative of the virtual boundary and to deliver content to mobile devices within the virtual boundary. The goefencing platform is configured to apply a machine learning model configured to: receive input data including at least one of engagement data, third-party data, a number of mobile devices in a region, a speed of the movable object, a number of mobile devices in the virtual boundary, or a predicted number of engagements, and determine, based on the input data, one or more configuration parameters for the virtual boundary, the configuration parameters including at least one of the one or more particular dimensions of the virtual boundary, the tail length, or the shape.

These systems can have one or more of the characteristics described for the first system above, and/or other characteristics as described throughout this disclosure. Moreover, the described systems can be associated at least with corresponding methods, processes, devices, and/or instructions stored on non-transitory computer-readable media.

Some implementations of the present disclosure, by providing active, dynamic adjustment of virtual boundary dimensions and other parameters, can facilitate reduced network and processing burdens. Because digital content provision can be targeted at well-controlled geographic regions for high efficiency, the amount of network and processing resources consumed in delivering content can be reduced. In addition, in some implementations, location polling that allows movable geofences to track movable objects can be dynamically adjusted so that the location polling does not consume excessive network and processing resources. Moreover, in some implementations, device number is determined based on feedback data based on user interactions with previously-delivered content, reducing network and processing burdens compared to approaches in which only other forms of device counting are used.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a diagram illustrating an example of a virtual boundary associated with a movable object.

FIG. 2 is a diagram illustrating an example of a system for content delivery.

FIG. 3 is a diagram illustrating examples of criteria and configuration parameters.

FIGS. 4A-4B are diagrams illustrating examples of virtual boundary dimension adjustment.

FIGS. 5A-5B are diagrams illustrating examples of tail length adjustment.

FIG. 6 is a diagram illustrating an example of a virtual boundary.

FIG. 7A is a diagram illustrating an example of engagement tracking.

FIG. 7B is a diagram illustrating an example of content provision.

FIG. 8 is a diagram illustrating an example of a virtual boundary.

### DETAILED DESCRIPTION

This disclosure relates to geofences based on locations of movable objects. These geofences move with a movable object, such that content can be allocated to devices in proximity to the movable object. In comparison to geofences based on non-movable objects (e.g., geofences defining an area around a store), geofences based on movable objects present technical and practical challenges for efficient content allocation. In implementations according to this disclosure, configuration parameters for a geofence are actively adjusted (e.g., in real-time) based on device and/or user data, such as device density data, to allow for active re-definition of the geofence boundaries. This can facilitate decreased network burdens and improved content distribution performance compared to geofences based on static geofences. In some implementations, for example, where the movable object has a digital display which has the ability to change content in real-time, the content displayed can change in real-time based on various factors such as the location of the object, the time of day, the surrounding environment, and marketing campaign goals. As the content displayed on the movable object changes, the content delivered to the devices within the geofence also changes accordingly, maintaining a relevant and engaging connection between the movable object and the devices.

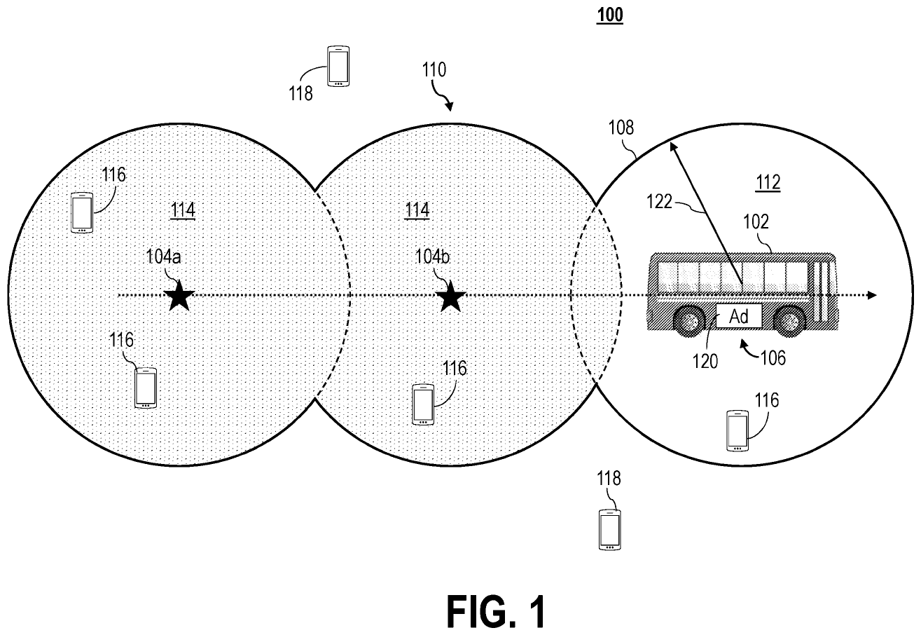

FIG. 1 illustrates an example of an environment 100 in which a geofence (sometimes referred to as a “virtual boundary”) is defined. A movable object 102 (illustrated in this example as a bus) navigates through the environment 100, e.g., from a first prior location 104a, to a second prior location 104b, to a current location 106. Based on location(s) of the movable object 102 over time (e.g., locations 104a, 104b, and/or 106), dimensions of a virtual boundary 108 are defined. The virtual boundary 108 defines a region 110 bounded by the virtual boundary 108. In this example, as described in further detail below, the region 110 includes a first portion 112 associated with the current location 106 and a second portion 114 associated with the prior locations 104a, 104b. Content is allocated to mobile devices 116 within the virtual boundary 108, while mobile devices 118 outside the virtual boundary 108 may not receive the content. This real-time adjustment of the geofence based on the density of devices within a region allows for efficient allocation of network resources, as the system can dynamically adjust the size and shape of the geofence to encompass an optimal number of devices, allowing for efficient use of network resources and reduces latency in content delivery.

This arrangement can be used for various purposes, such as information dissemination, public outreach, and advertising. For example, in some implementations, the movable object 102 displays real-world content 120, such as a video played on a mounted monitor. Users in the vicinity of the movable object 102 (for example, walking on a sidewalk adjacent to a road traversed by the movable object 102, or sitting at a cafe with a sightline to the movable object 102) may see the real-world content 120 on the movable object 102 and, at the same time or shortly afterwards, receive content on their mobile device 116 (e.g., a phone) that is associated with the real-world content 120. For example, the real-world content 120 may be an advertisement for a movie, and the content delivered to the mobile device 116 may be a banner advertisement that, when selected, brings the user to a website for buying tickets to the movie. Because the display of the banner advertisement is based on the mobile devices'116 inclusion in the region 110, and because the region 110 is bounded by the virtual boundary 108 defined based on the locations 104a, 104b, 106 of the movable object 102, users of the mobile devices 116 are likely to have seen the real-world advertisement and, therefore, may be more likely to interact with the banner advertisement.

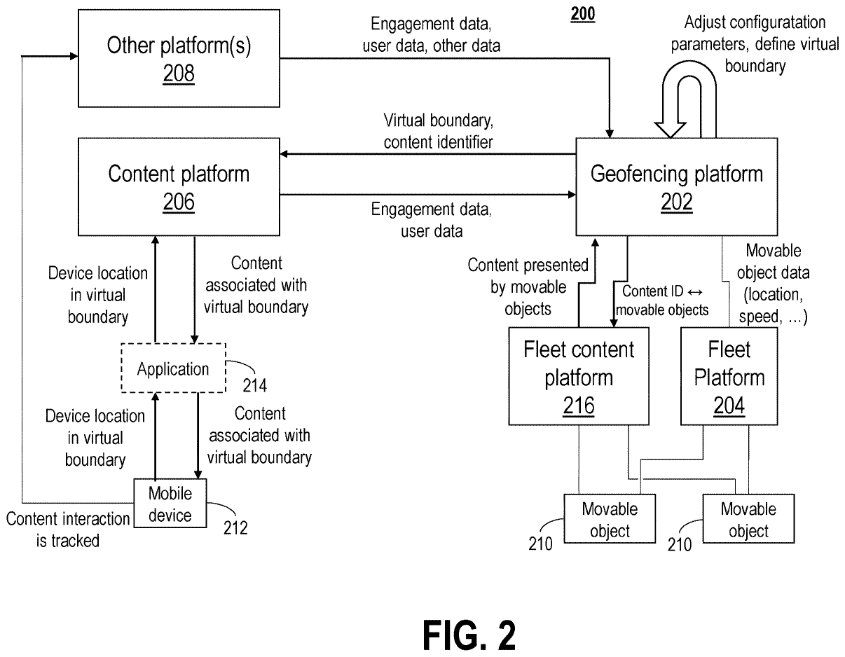

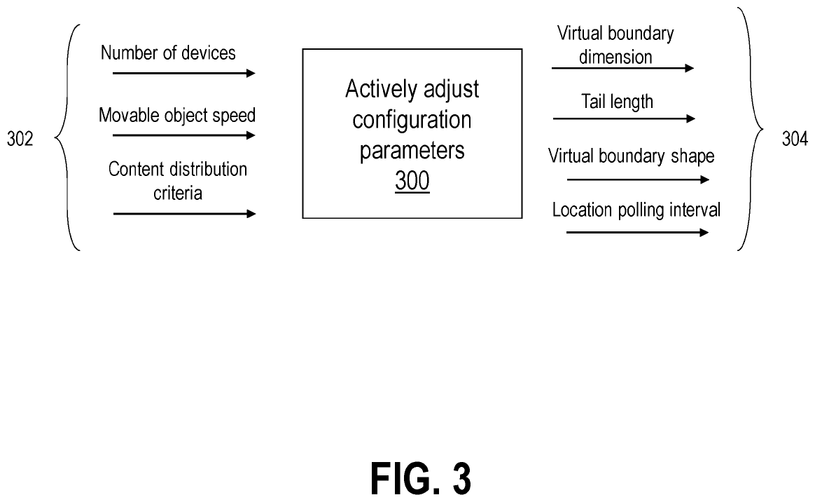

FIG. 2 illustrates an example of a system 200 that can be used to carry out content allocation using geofences based on movable objects. The system 200 includes a geofencing platform 202 that configures and adjusts geofences; a fleet platform 204 that communicates with movable objects 210 (e.g., having characteristics as described for movable object 102); a content platform 206 that delivers content to mobile devices 212 within the geofences; an optional fleet content platform 216 that controls dynamic content displayed on the movable objects 210; and one or more other platforms 208 that may provide additional information to the geofencing platform 202, such as engagement data, mapping data, weather data, and/or traffic data. In an example of interactions between elements of the system 200, the geofencing platform 202 queries the fleet platform 204 to obtain geographic locations of one or more movable objects 210. The geofencing platform 202 defines dimensions of a virtual boundary based on the locations and based on one or more configuration parameters, described in further detail with respect to FIGS. 3-8. The geofencing platform 202 sends data indicative of the virtual boundary to the content platform 206 (along with, in some implementations, a content identifier indicating particular content to be delivered, e.g., a campaign identifier), which delivers content to one or more mobile devices 212 within the virtual boundary. For example, the mobile device 212 may access an application 214, which obtains the location of the mobile device 212 and sends the location to the content platform 206, such that the content platform 206 determines that the mobile device 212 is within the virtual boundary and delivers the content to the mobile device 212. The system 200 enables efficient and targeted content delivery to mobile devices within the geofences by using geofences based on movable objects to carry out content allocation. The geofencing platform 202 configures and adjusts geofences, and communicates with the fleet platform 204 to obtain the geographic locations of movable objects 210. The content platform 206 then delivers content to mobile devices 212 within the geofences. This process reduces network or computing resource use by delivering content only to the devices within the geofences, which is a more efficient use of resources compared to blanket content delivery to all devices.

As this process repeats (e.g., to reflect updated current locations of the movable objects 210), the geofencing platform 202 actively (e.g., periodically, continuously, and/or in response to one or more triggers) adjusts the configuration parameters and defines the dimensions of the virtual boundary based on the updated configuration parameters. For example, in some implementations, the geofencing platform 202 adjusts the configuration parameters based on a number of mobile devices within a region, such as within the virtual boundary. For example, the geofencing platform 202 can reduce or increase a radius (e.g., radius 122 of FIG. 1) of the virtual boundary or a portion thereof. Accordingly, each iterated virtual boundary defined by the geofencing platform 202 can be configured and updated to improve network transmission efficiency and provide improved content delivery performance. In some embodiments, this dynamic adjustment of the virtual boundary also takes into account the dynamic content displayed on the movable object 210 and the corresponding dynamic content to be delivered to the mobile devices within the virtual boundary.

In some implementations, the adjustment of the configuration parameters is “active” in that the adjustment occurs during navigation by a movable object 210, e.g., during route traversal by the movable object 210 and corresponding to the currently displayed content on the movable object, in cases where the content is displayed on a dynamically changing digital display. For example, the configuration parameters can be adjusted every time a current location of the movable object 210 is obtained (e.g., periodically with the timing of the polling interval described in more detail below), or periodically with a relatively short timespan between adjustments, e.g., less than one minute or less than two minutes. Accordingly, the configuration parameters can be dynamically updated to reflect current conditions of the movable object 210 and its surroundings. In some implementations, the adjustment is performed automatically, e.g., by a computer system of the geofencing platform 202.

In some implementations, the distribution of content is associated with a “campaign,” e.g., a combination of movable object(s) 210, content for distribution, and campaign parameter(s) that guide distribution of the content, such as a total amount of content to be distributed, a period of time over which the content is to be distributed, and/or user characteristic(s) (e.g., demographic characteristics) to be targeted for the content. As described in further detail below, these and/or other campaign parameters can serve as a basis for adjustment of configuration parameters of geofences. An example of a campaign is an anti-smoking public service announcement campaign in which a flying drone displays an anti-smoking message. A geofence is defined based on location(s) of the flying drone, and mobile devices in the geofence are provided with advertisements for free nicotine patches; users can interact with the advertisements to receive the free nicotine patches. This campaign may be configured, for example, to run for the lesser of four weeks or until 10,000 nicotine patches have been distributed.

The movable objects 210 can be one or more types of movable object. In various implementations, the movable objects 210 include road vehicles (e.g., buses, trucks, and/or cars), aerial vehicles (e.g., drones, planes, and/or helicopters), rail vehicles (e.g., metro railcars), nautical vehicles (e.g., boats), human-operated vehicles (e.g., bicycles, scooters and/or motorcycles), and/or human-associated objects (e.g., a particular person, or an object carried by a person). The movable objects 210 can be public transportation vehicles, delivery vehicles, rideshare vehicles, taxis, mobile tourist attractions, mobile retail locations (e.g., food trucks or pop-up shops), mobile entertainment locations (e.g., mobile stages), and/or people of interest (e.g., celebrities, influencers, and mascots). An example of a movable object is a billboard truck having a large billboard display or digital display (e.g., an advertising billboard) on one or both sides. When the geofencing platform 202 has access to locations of multiple movable objects 210, the geofencing platform may define a virtual boundary for each movable object 210.

In some embodiments, the content displayed on the billboard or other presentation device of the movable objects 210 changes with time. For example, the content can change according to a set schedule (e.g., rotating advertisements according to a preset interval, such as every five minutes), and/or can be dynamically adjusted in real-time based on various factors such as campaign goals and settings, the current location of the movable objects 210, time, surrounding environment, and/or user engagement data, among other things. This adjustment of the content on the movable objects 210 can, in some implementations, be associated with a corresponding dynamic adjustment of the content delivered to the mobile devices within the virtual boundary defined around the movable objects 210. Content adjustment can be performed using a fleet content platform 216, as discussed in further detail below. The content can be adjusted dynamically and in real-time, e.g., as the movable object moves around in the environment, in a dynamic manner as discussed herein for dynamic adjustment of virtual boundaries.

In some implementations, the movable objects 210 include interactive elements, e.g., a scannable code (e.g., a QR code), an interactive kiosk/console/display, or a giveaway (e.g., free product samples being handed out from a window of a truck that is a movable object 210). In some implementations, as described above in reference to real-world content, the movable objects 210 present visual content, such as an advertisement or a notice. In some implementations, the movable objects 210 present audio and/or video content, such as an audio announcement, audio advertisement, video content or video advertisement. In some embodiments, the movable objects 210 present content that can be dynamically updated, for example, based on campaign settings or goals, the location, time, and/or surrounding environment of the movable objects 210, among other factors. In some implementations, the movable objects 210 provide a network connection (e.g., a Wifi connection or a Bluetooth connection) accessible to mobile devices, e.g., to access content associated with the campaign. In some implementations, the movable objects 210 are configured with an Internet connection or other network connection to receive instructions from the fleet content platform 216 to determine what content to present.

Each of the geofencing platform 202, the fleet platform 204, the content platform 206, the fleet content platform 216, and other platform(s) 208 can include one or more computer systems in one or more locations. For example, one or more of the platforms 202, 204, 206, 208, 216 can include a cloud computing system and/or a server. The platforms 202, 204, 206, 208, 216 can be configured to perform operations, e.g., the processes described throughout this disclosure. For example, the platforms 202, 204, 206, 208, 216 can include one or more computer-readable storage media and one or more processors, and the computer-readable storage media can include instructions that, when executed, cause the platforms 202, 204, 206, 208, 216 to perform the described operations.

The illustrated arrangement of platforms in FIG. 2 is an example; in some implementations, two or more of the platforms 202, 204, 206, 208, 216 can be partially or wholly combined into a single platform, and/or one or more of the platforms 202, 204, 206, 208, 216 can be split into multiple platforms having, for example, separate respective computer systems. The platforms 202, 204, 206, 208, 216 can exchange data over one or more networks, e.g., the Internet.

The fleet platform 204 can be configured to obtain/determine geographic location(s) of the movable object(s) 210 and to provide the locations to the geofencing platform. For example, each movable object 210 may include a global navigation satellite system (GNSS) receiver, the output of which indicates the location of the movable object 210. The output can be sent from the movable object 210 to the fleet platform 204, e.g., in the form of GNSS coordinates, latitude/longitude, and/or street address. In some implementations, such as when the movable objects 210 include mass transit vehicles, the geographic location data is in General Transit Feed Specification (GTFS) format. Other location data formats are also within the scope of this disclosure.

In some implementations, the geofencing platform 202 periodically queries the fleet platform 204 to obtain the locations of the movable objects 210. For example, the geofencing platform 202 may query the fleet platform 204 at a location polling interval. In some implementations, in response to the geofencing platform 202 querying the fleet platform 204 to obtain the locations, the fleet platform 204 itself performs a querying process to obtain the locations and provide the locations to the geofencing platform 202. In some implementations, location determination may be associated with significant network resource and/or processing resource usage. For example, a single iteration of location determination can include multiple transfers of data over one or more networks (e.g., between the geofencing platform 202 and the fleet platform 204 and/or between the fleet platform 204 and the movable objects 210), with corresponding computer processing associated with each data transfer and with determination of the location itself (e.g., operation of a GNSS module of a movable object 210). Moreover, in some cases, network resources associated with the movable objects may be limited. Accordingly, computer/network function can be improved (e.g., resources consumed can be reduced) by appropriate configuration of the polling interval, as described in further detail below.

The fleet content platform 216 can control and/or query what content is presented by the movable objects 210 as a function of time. For example, the fleet content platform 216 can send commands and/or other data to the movable objects 210 to control the content presented by the movable objects 210. For example, if a movable object 210 is in an area having higher-than-average interest in a topic (e.g., based on consumer data), the fleet content platform 216 can cause the movable object 210 to present content associated with the topic. As another example, the fleet content platform 216 can cause a movable object 210 to present content responsive to weather and/or other conditions of the movable object's current location, e.g., an advertisement that notes the presence of rain when the movable object 210 is in a rainy location.

In some implementations, the determination of what content to present using the movable objects 210 is performed by the fleet content platform 216 without necessarily receiving input from the geofencing platform 202. For example, the fleet content platform 216 can determine the content, and the geofencing platform 202 can query the fleet content platform 216 to receive data indicative of the content presented on each movable object 210. For example, the geofencing platform 202 can receive data having a structure (fleet_ID, content_ID), where fleet ID indicates a particular movable object 210 and content_ID indicates particular content presented using the movable object 210. In some implementations, instead of or in addition to the geofencing platform 202 querying the fleet content platform 216, the fleet content platform 216 can push the data to the geofencing platform 202. Data exchange can occur according to a preset schedule, e.g., every 10 seconds or every 30 seconds.

In some implementations, at least some of the content presented by the movable objects 210 is determined by the geofencing platform 202. For example, the geofencing platform 202 can send, to the fleet content platform 216, data indicative of (i) particular content to present using the movable objects 210, and (ii) which movable object(s) 210 are to present the particular content. The movable objects 210 to present particular content can be indicated by identifiers of the movable objects 210 (e.g., identifiers used by the fleet platform 204 to report locations of the movable objects 210) and/or can be in the form of a virtual boundary, e.g., where the geofencing platform 202 instructs the fleet content platform 216 to present certain content using movable objects 210 that fall within a virtual boundary provided by the geofencing platform 202 to the fleet content platform 216. The geofencing platform 202 can select the content based on any of the parameters described throughout this disclosure for adjustment of the virtual boundary or selection of content to deliver to mobile devices. For example, the geofencing platform 202 can select the content based on at least one of a location of the movable object, a time (e.g., time of day or day of the week), a surrounding environment of the movable object (e.g., a density of mobile devices, current weather, etc.), engagement data indicative of past interactions of mobile devices (e.g., with content delivered to the mobile devices based on the mobile devices being within a virtual boundary as discussed herein), and/or marketing campaign goals

Regardless of whether the geofencing platform 202 and/or the fleet content platform 216 determines which movable objects 210 are to present which adjustable content, in some implementations, the content provided to mobile devices within geofences around the movable objects 210 can be selected to match the adjustable content, as discussed in further detail below.

Although illustrated as separate, in some implementations the fleet content platform 216 can be integrated together with the fleet platform 204 and/or the content platform 206, and/or another platform, as a unified platform.

The geofencing platform 202 can be a platform that manages geofences for one or more campaigns and performs virtual boundary configuration as described herein. The content platform 206 can be a platform that obtains mobile device locations and delivers content to the mobile devices on behalf of the geofencing platform 202 and, in some cases, one or more other platforms. For example, in some implementations the content platform 206 is an ad network. When a mobile device is operated, the mobile device sends (directly or indirectly) its location and a request for data to the content platform 206. The content platform 206 determines content, such as an ad, to send to the mobile device 212, from among many possible content available to the content platform 206. When the mobile device is inside a virtual boundary sent by the geofencing platform 202, the content platform 206 can determine that the mobile device is eligible to receive content corresponding to a content identifier provided by the geofencing platform 202 in association with the virtual boundary, and the content platform 206 sends the content to the mobile device. The content can include, for example, banner ads, push notifications, text messages, voice messages, and/or any other type of content (e.g., digital content) deliverable to mobile devices 212.

At any given time, the geofencing platform 202 may be operating multiple campaigns, each associated with multiple movable objects. Each campaign may be associated with one or more content identifiers that identify what content is to be delivered to mobile devices within one or more virtual boundaries of the campaign.

In some implementations, the content identifiers provided by the geofencing platform 202 are based on dynamic content presented by the movable objects 210, e.g., digital billboards that display rotating and/or otherwise changing (e.g., based on movable object context) content. The content identifiers can be associated with geofence(s) and can indicate particular content that is to be presented to mobile devices within the geofences, where the particular content is associated with (e.g., complementary to) particular adjustable content presented by movable object(s) with which the geofence(s) are associated (e.g., around which the geofence(s) are located). This dynamic adjustment of content allows for more relevant and engaging content to be delivered to the devices within the geofence, thereby improving user engagement and reducing waste of network resources.

For example, a movable object 210 can display, in rotation or otherwise adjustably displayed, two advertisements associated with two campaigns. When the first advertisement is presented on the movable object 210, the geofencing platform 210 sends a first content identifier to the content platform 206 to trigger, to mobile devices within a virtual boundary associated with the movable object 210, delivery of first content associated with the first advertisement. For example, the first advertisement can be an advertisement for a restaurant chain, and the first content can be a coupon for the restaurant chain. When the second advertisement is presented on the movable object 210, the geofencing platform 210 sends a second content identifier to the content platform 206 to trigger, to mobile devices in a virtual boundary associated with the movable object 210, delivery of second content associated with the second advertisement. For example, the second content can reference the second advertisement, e.g., display “A Bus Showing Our Movie Trailer Is Approaching!” As this is occurring, the geofence associated with the movable object 210 is being dynamically adjusted as discussed throughout this disclosure. As noted above, the first content and the second content can be presented as determined by the fleet content platform 216 or as determined by the geofencing platform 202

In some implementations, the adjustable content presented by movable objects 210 can include (possibly among other content) multiple content associated with a single campaign. In an example of a process of content selection and adjustment, a geofencing platform 202 determines, based on data from the fleet platform 204, that a movable object 210 has moved into a particular neighborhood. The movable object 210 is displaying content for an advertising campaign for a restaurant chain, and the content includes multiple different content corresponding to different food items offered by the restaurant chain. Based on data from the content platform 206 and/or the other platforms 208 (e.g., demographic data and/or user engagement data), the geofencing platform determines that users in the neighborhood are particularly likely to prefer a first food item of the different food items. As such, the geofencing platform 202 sends an instruction to the fleet content platform 216 to cause the movable object 210 to present an advertisement featuring the first food item. In addition, the geofencing platform 202 dynamically adjusts a size and/or shape of a virtual boundary around the geofencing platform 202, e.g., based on a number of user devices in the neighborhood and/or other factor(s) as discussed herein. The geofencing platform 202 sends, to the content platform 206, the virtual boundary and a content identifier indicating content complementary to the advertisement featuring the first food item. For example, the content can be a coupon for the first food item. This data from the geofencing platform 202 triggers the content platform 206 to deliver the content to mobile devices within the dynamically-adjusted virtual boundary around the movable object 210.

The mobile devices 212 can include one or more types of user device, e.g., smart phones, laptops, tablets, smart watches, wearable devices (e.g., AR/VR devices), and/or other user electronics.

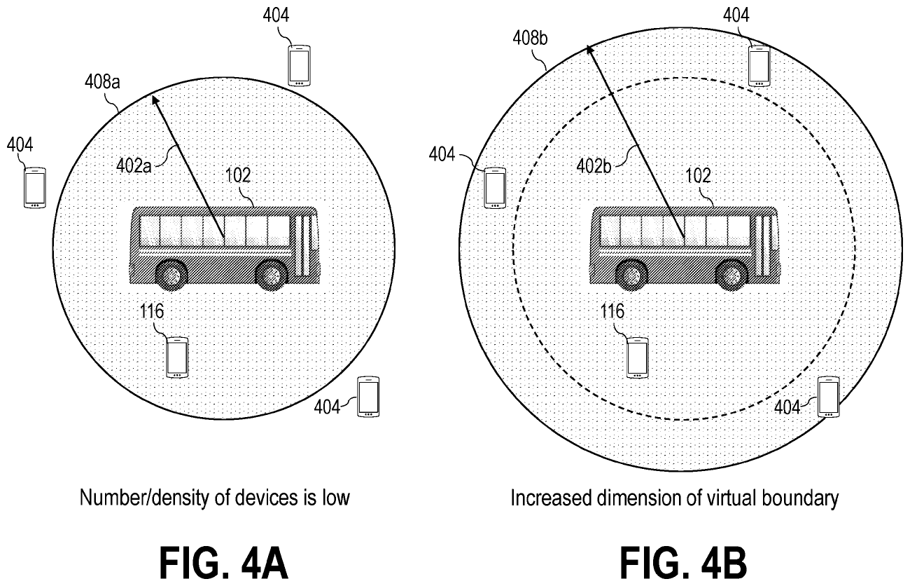

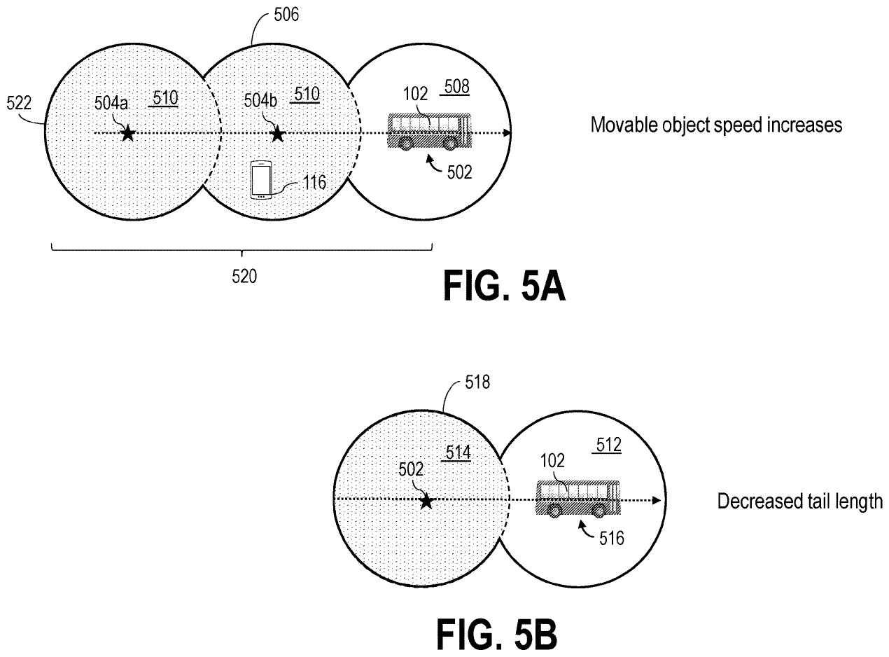

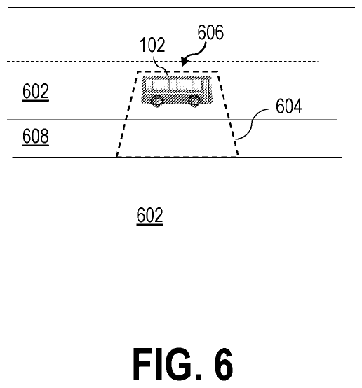

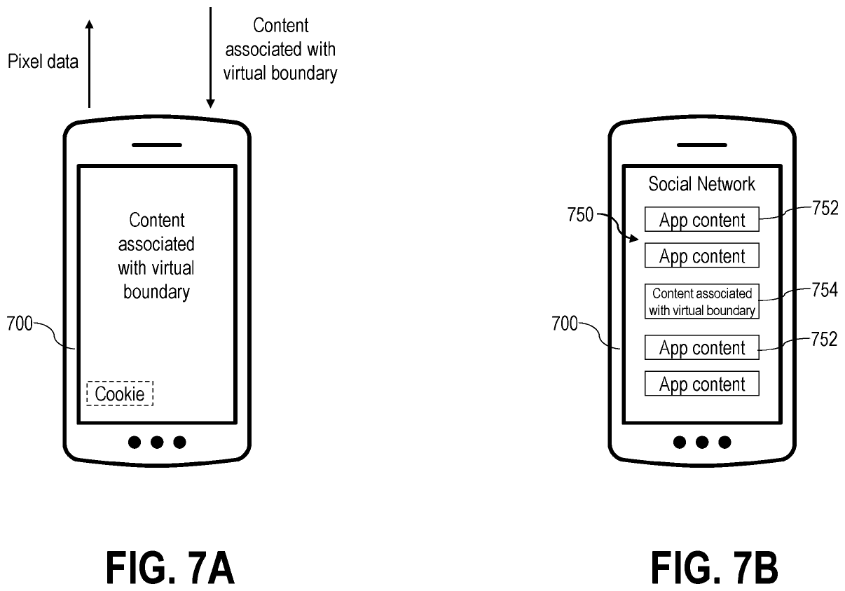

FIG. 3 illustrates examples of criteria 302 based on which the configuration parameters can be actively adjusted (300) and examples of the configuration parameters 304 that can be adjusted. The criteria 302 include a number of mobile devices within a region (discussed in further detail in reference to FIGS. 4A-4B), a speed of the movable object (discussed in further detail in reference to FIGS. 5A-5B), and content distribution criteria. The configuration parameters 304 include one or more particular dimensions of the virtual boundary (e.g., widths of one or more portions of the virtual boundary), a tail length (discussed in further detail in reference to FIGS. 5A-5B), a shape of the virtual boundary (discussed in further detail in reference to FIGS. 6 and 7), and the polling interval. Each of these and other configuration parameters 304 can be adjusted based on one or more of the criteria 302, e.g., in some implementations, in a joint manner based on multiple criteria 302 together.

FIGS. 4A-4B illustrate an example of virtual boundary dimension adjustment based at least on a number of mobile devices in a region. As shown in FIG. 4A, a first virtual boundary 408a is defined in proximity to a location of a movable object 102, the first virtual boundary 408a having a dimension (in this example, a radius) 402a. A mobile device 116 is within the virtual boundary 408a, while other mobile devices 404 are outside the virtual boundary 408a.

As at least part of its active adjustment of the configuration parameters, the geofencing platform 202 determines a number of mobile devices within a region. In some implementations, the region is a region bounded by a current virtual boundary, e.g., inside the first virtual boundary 408a of FIG. 4A. In some implementations, the region is a larger region that includes the region bounded by the current virtual boundary. For example, the virtual boundary can define a circle with a first radius centered at the location of the movable object, while the region within which the number of mobile devices is determined can be a circle with a second radius, larger than the first radius, centered at the location of the movable object. In some implementations, the region is a geographic region in which the movable object is navigating, e.g., a neighborhood, a town, or a city. In some implementations, determining the number of mobile devices within the region includes determining a density of mobile devices within the region, e.g., based on an area of the region.

The geofencing platform can obtain one or more types of data to determine the number of mobile devices within the region. In some implementations, the number of mobile devices is determined at least partially based on engagement data characterizing user interaction with previously-delivered content, e.g., content delivered to mobile devices during the campaign and/or other content allocation campaigns. For example, in some implementations, the geofencing platform 202 receives data indicating an amount of interactions with the previously-delivered content. This data can include a number of impressions (times the delivered content is viewed), clicks (times the delivered content is selected by a user), conversions (times a user follows through on an objective of the delivered content, e.g., makes a purchase or books a reservation after selecting delivered content), and/or other types of engagement data. Based on the engagement data (e.g., by counting a number of mobile devices on which delivered content was interacted with), the geofencing platform 202 determines the number of mobile devices within the region.

In some implementations, the engagement data is received at the geofencing platform 202 from the content platform 206 and/or from another platform 208, such as a platform associated with the delivered content. For example, after a user interacts with delivered content and makes a purchase from a merchant, a notification of the purchase may be sent from the merchant or from a payment processor to the geofencing platform 202.

In some implementations, engagement data is received at the geofencing platform 202 based on the delivered content itself. As shown in FIG. 7A, when content associated with a virtual boundary is delivered to a mobile device 700, the content can deliver a tracking pixel and/or a cookie to the mobile device 700. Alternatively, or in addition, a tracking pixel and/or cookie can be received at the mobile device 700 after the delivered content is interacted with, e.g., after a user clicks a displayed banner ad to be redirected to another page, by appropriate configuration of the delivered content. A cookie is a portion of data stored on the mobile device 700 that allows activities of the mobile device 700 to be tracked, e.g., browsing activity, form entries, and web/application interactions. A tracking pixel (sometimes referred to as a marketing pixel) allows a number of visitors to a web page to be tracked, along with, in some cases, user/device information such as device IP (Internet Protocol) address. For example, when a user interacts with delivered content and is brought to a web page, the web page can include the tracking pixel, such that a request is sent to a server hosting the tracking pixel. By accessing the server or an associated platform/system (e.g., another platform 208), and/or by receiving data stored thereon, the geofencing platform 202 can obtain the engagement data.

Moreover, in some implementations, the use of cookies and/or pixels can allow the geofencing platform 202 to obtain user data corresponding to interactions. For example, the geofencing platform 202 can obtain data indicative of user behavior and/or preferences, such as the digital content with which users have interacted, the physical products with which users have interacted, locations to which the users have traveled, amounts of time users spend on landing pages after interacting with delivered content, and/or physical products users have purchased, based on cookie-based tracking and/or correlating user information (e.g., an IP address obtained using a pixel) with third-party information, such as third-party information obtained from another platform 208.

These and other types of data can be used to enhance the effectiveness and efficiency of content distribution campaigns. For example, in some implementations, in response to engagement data indicating that a particular area exhibits a high concentration of impressions and/or conversions, the geofence can be defined (e.g., by decreasing, increasing, or otherwise adjusting a particular dimension of the virtual boundary) to encompass that area, and/or particular content can be sent to mobile devices in that area (e.g., by the geofencing platform 202 sending a virtual boundary that includes the area and a corresponding content identifier indicative of the particular content). In addition, or alternatively, geofences can be defined to exclude areas exhibiting fewer impressions and/or conversions, and/or to provide particular content to mobile devices in those areas, e.g., content designed to increase engagement.

As another example, in some implementations, personalized content can be delivered to a user's mobile device based on engagement data previously obtained about the user. For example, a cookie deposited on a user's mobile device based on content delivery can allow the geofencing platform 202 to track the user's subsequent behavior and preferences. When the mobile device is subsequently in another virtual boundary so as to receive further content, the delivered content can be personalized based on the user's past behavior. In some embodiments, this personalization process also takes into account the dynamic content displayed on the movable object within the virtual boundary and the corresponding dynamic content to be delivered to the mobile device. This dynamic content matching process ensures that the content delivered to the mobile device is current, relevant and engaging.

For example, as shown in FIG. 7B, a user may access a social network interface 750, e.g., a social network feed or a sequence of social media content (e.g., a sequence of images and/or video). The interface 750 includes application content 752, such as news, social network media, posts, etc. The interface 750 further includes content 754 associated with the virtual boundary, e.g., content delivered to the mobile device 700 based on the mobile device 750 being within a virtual boundary. The content 754 can include, for example, a sponsored/promoted post, a banner advertisement, or another type of content. In some implementations, when the content 754 is displayed, an indicator of the display (an indicator of an “impression”) is stored and/or delivered, e.g., sent to the geofencing platform 202, the content platform 206, and/or another platform 208, as engagement data. The geofencing platform 202 can obtain the engagement data from the content platform 206 and/or the other platform 208. The impression can be identified based on, for example, a tracking pixel in the content 754 and/or another method.

Moreover, in some implementations, when the user interacts with the content 754, the mobile device 700 may navigate to another interface (e.g., a landing page or a purchase page) that may have an associated tracking pixel and/or other included data element to track (as engagement data) that the user has interacted with the content 754. In some implementations, in response to the user interacting with the content 754, a cookie is stored on the mobile device 700. The cookie can be used to generate engagement data indicating activities performed on the mobile device 700, locations to which the mobile device 700 is taken, etc., which can be obtained by the geofencing platform 202 to guide adjustment of configuration parameters and/or customization of content based on engagement data, as described throughout this disclosure.

Referring again to FIG. 4A, instead of or in addition to determining the number of mobile devices based on engagement data, in some implementations the geofencing platform obtains third-party data (e.g., from another platform 208) that includes or indicates the number of mobile devices. For example, some third-party services provide device location data and/or device density data based on, for example, GNSS data, radio-frequency identification (RFID) device detection, Wifi device detection, cellular network device detection, social media data (e.g., a number of users posting on a social media service from the region), census data, traffic data, and/or weather data. For example, high levels of traffic in traffic data can indicate a high number of mobile devices, while inclement weather can indicate a low number of mobile devices. As another example, Wifi device localization (e.g., triangulation) may be useful for locating mobile devices within buildings, e.g., based on a knowledge of which portions of a building are covered by different Wifi networks. The geofencing platform 202 can obtain this data and/or data derived therefrom and, based on the data, determine a number of mobile devices in the region.

The use of engagement data and/or third-party data to determine the number of mobile devices in the region can reduce consumption of network and/or processing resources. For example, the additional network and/or processing resources required to count a mobile device, given the mobile device's interaction with delivered content, may be relatively small compared to the resources consumed using other method(s), such as network-based methods that use, for example, local wireless networks to count mobile devices. For example, it may be taxing for mobile devices (e.g., smart phones) to perform the handshaking/network interactions associated with obtaining real-time mobile device locations. Engagement data and/or third-party data can be obtained on the “back end” without requiring further interactions with mobile devices to determine the number of mobile devices in the region.

In some implementations, instead of or in addition to using the engagement data and/or third-party data, the geofencing platform 202 determines the number of mobile devices in the region based on mobile device interactions with a wireless network (e.g., a Bluetooth network) associated with a movable object 210. For example, a movable object can include a mounted network beacon (e.g., a Bluetooth beacon) that searches for nearby mobile devices. Based on a number of identified mobile devices (e.g., a number of mobile devices that interact with the wireless network), the geofencing platform 202 can determine the number of mobile devices in the region.

The determined number of mobile devices in the region need not be (though can be) an exact count of the mobile devices. Rather, in some implementations, the determined number of mobile devices in the region represents an estimate, e.g., based on trends and available data. The determined number of mobile devices in the region can be a number of mobile devices in the region over a defined period of time, e.g., over the course of a day, an hour, or in real-time, and/or an average number of mobile devices in the region over the defined period of time.

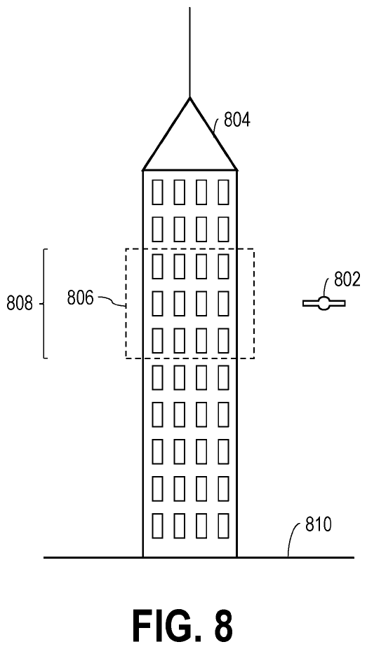

Based on the number of mobile devices in the region (however determined), the geofencing platform 202 adjusts one or more configuration parameters, such as a particular dimension of the virtual boundary and/or the tail length. The particular dimensions of the virtual boundary, the tail length, and the shape can together define the dimensions of the virtual boundary, e.g., the overall size and overall shape of the virtual boundary. Examples of particular dimensions include a radius of the virtual boundary or a portion thereof (e.g., radii of multiple portions of the virtual boundary, each portion surrounding a respective current or prior location of a movable object); a width or length of the virtual boundary or a portion thereof (e.g., a width of the virtual boundary or a portion thereof surrounding a transit route path with a corridor shape, or a length of a portion of the virtual boundary extending from a location of the movable object down an adjacent road); and a height of the virtual boundary or a portion thereof (described in more detail below in reference to FIG. 8). In some implementations, one or more particular dimensions of the virtual boundary are defined in reference to (current and/or prior) locations of the movable object, e.g., a particular dimension may be a distance between the virtual boundary and a location of the movable object, or a distance between the virtual boundary and a path connecting two locations of the movable object. In some implementations, the particular dimensions are associated with an area or volume of the area defined by (enclosed by) the virtual boundary, such that increasing a particular dimension increases the area or volume, and decreasing a particular dimension decreases the area or volume.

In the example of FIGS. 4A-4B, the first radius 402a (an example of a particular dimension) of the virtual boundary 408a is increased to a larger radius 402b that defines a larger virtual boundary 408b. The larger virtual boundary 408b encloses mobile devices 404 that would otherwise have been outside the virtual boundary, such that content is delivered to the mobile devices 404. For example, in some implementations, in response to an increase in the number of mobile devices, one or more particular dimensions (e.g., radius, width, and/or length) of the virtual boundary can be decreased, and, in response to a decrease in the number of mobile devices, the dimension(s) of the virtual boundary can be increased. In some implementations, the adjustment of the particular dimension(s) is performed based on a target number of mobile devices within the virtual boundary: a lower density of mobile devices may mean that the particular dimension(s) are increased so that the target number of mobile devices is enclosed (by including additional mobile devices with the virtual boundary), and a higher density of mobile devices may mean that the particular dimension(s) are decreased so that the target number of mobile devices is enclosed (by excluding mobile devices from the region defined by the virtual boundary). In a non-limiting example, for all other criteria and configuration parameters held constant, the particular dimension(s) can be adjusted so that the area of the region (or, in implementations that include a three-dimensional region, a volume of the region) enclosed by the virtual boundary is inversely proportional to a density of mobile devices in the region.

This dynamic, active adjustment of the size of the virtual boundary may result in a more refined set of mobile devices selected to receive content. For example, users of mobile devices that are closer to the movable object may be more likely to interact with delivered content, e.g., because these users are more likely to have seen and/or interacted with real-world content of the movable object. Accordingly, when the number of mobile devices is relatively high, the region enclosed by the virtual boundary can be made relatively small (while still retaining a sufficient number of enclosed mobile devices), so that content delivery less likely to lead to engagement (e.g., content delivery to mobile devices further from the movable object) can be decreased. This may result in more efficient utilization of network resources and/or a decrease in the total amount of network resources consumed. In addition, campaign performance may be improved, e.g., in that each portion of delivered content may be more likely to lead to user engagement.

FIGS. 5A-5B illustrate an example of tail length adjustment based on the criteria 302. In some implementations, the region enclosed by the virtual boundary includes a first portion surrounding a current location of the movable object and a second portion surrounding one or more prior locations of the movable object. For example, as shown in FIG. 1, the virtual boundary 110 encloses a first region 112 surrounding the current location 106 and a second region 114 surrounding two prior locations 104a, 104b. The second portion/region can be referred to as a “tail” region, because it represents a region that follows behind the current location.

The region enclosed by the virtual boundary need not surround the current location and/or prior location(s). For example, in some implementations the virtual boundary is defined to enclose a region in proximity to, but excluding, the current location and/or the prior locations. For example, when the movable object is a vehicle on a street, the virtual boundary may enclose a sidewalk adjacent to the street, a building adjacent to the street, without enclosing the current and/or prior locations of the vehicle itself. Accordingly, in some implementations, the virtual boundary includes a first portion associated with the current location and/or a second portion associated with prior location(s), where the current locations and/or the prior location(s) need not be surrounded. A portion of the virtual boundary may be associated with a location in that the portion of the virtual boundary defines a region in proximity to the location and/or is defined based on the location, e.g., has a particular dimension (e.g., radius, width, height, etc.) with respect to the location, such as a particular radius around the location.

The tail region is included based on the recognition that users in the tail region may have witnessed and/or interacted with the movable object previously, even if the users are not in proximity to the current location of the movable object. For example, a user may have interacted with the movable object (e.g., taken a free sample product from the movable object) without presenting an opportunity for immediate content delivery, e.g., without using any applications on the user's mobile device while the movable object was in the user's vicinity. However, it may be possible to deliver the content to the mobile device at a later time, for example, when the user opens an application some time after the movable object has left. Accordingly, when the tail region is configured to surround one or more prior locations of the movable object, the tail region is likely to include mobile devices of users that interacted with the movable object, such that the inclusion of the tail region can increase the proportion of interacting users that receive delivered content.

In the example of FIGS. 5A-5B, a first virtual boundary 506 includes a first portion 508 surrounding a current location 502 of a movable object 102 and a second portion 510 (a tail region) surrounding two prior locations 504a, 504b of the movable object 102. When data indicative of the virtual boundary 506 is sent to the content platform 206 to trigger delivery of content, a mobile device 116 in the second portion 510 receives the content.

The second portion 510 can be characterized by a “tail length,” which may be defined in one or more ways. In some implementations, the tail length is a number of prior locations of the movable object 102 surrounded by the second portion 510, e.g., two, in the case of FIG. 5A. In some implementations, each prior location corresponds to a location query from the geofencing platform. For example, if the polling interval is 30 seconds, the prior locations correspond to locations of the movable object 102 every 30 seconds. Some or all prior locations (e.g., the latest n prior locations of each movable object) can be stored at the geofencing platform 202 and/or the fleet platform 204. The tail length can define the number of prior locations surrounded by the tail region, and each of the included prior locations can define a surrounding area (e.g., a circle, rectangle, or other polygon); the union of the areas surrounding each included prior location together form the tail region.

In some implementations, the tail length is defined by another metric. For example, in some implementations, the tail length is a distance 520 between the current location 502 and a back end 522 of the second portion 510, or a distance (not shown) between the current location 502 and an earlier prior location (in this example 504a) surrounded by the second portion 510. In some implementations, the tail length is a time between a current time (e.g., a time at which the movable object 102 is at the current location 502) and a time at which the movable object 102 was at the earlier prior location surrounded by the second portion 510. For example, the tail length can be ten minutes, such that the second portion 510 surrounds polled locations at which the movable object 102 was located in the prior ten minutes.

In some implementations, as a configuration parameter, the tail length can be actively adjusted based on one or more criteria to define the virtual boundary. A tail length that is too long may be more likely to include mobile devices of users who did not see or otherwise interact with the movable object, leading to unnecessary usage of network and/or processing resources in delivering content to those mobile devices. A tail length that is too short may not include mobile devices of users who did interact with the movable object, leading to worse campaign efficiency.

In some implementations, as in the example of FIGS. 5A-5B, the tail length is adjusted based on a speed of the movable object 102. When the speed is higher, a given user in the vicinity of a prior location of the movable object 102 may have been less likely to interact with the movable object, e.g., because the movable object 102 passes by the user more quickly. Accordingly, for the efficiency-related reasons described above in relation to FIGS. 4A-4B, in some cases it is desirable for the tail length to decrease when the movable object speed increases (e.g., with other criteria and configuration parameters held constant), and for the tail length to increase when the movable object speed decreases. These adjustments can allow the geofence to be targeted on areas having users most likely to interact with delivered content, in some cases reducing network and/or processing resources consumed.

For example, in FIG. 5A, with the movable object 102 moving at a first speed, the second portion 510 surrounds two prior locations 504a, 504b. The movable object 102 then speeds up and, as shown in FIG. 5B, proceeds to a new current location 516; location 502, previously the current location, is now a prior location 502. Based on the increase in speed, the geofencing platform 202 actively adjusts (decreases) the tail length to include only the most recent prior location, that is, location 502. Based on the adjusted tail length, the geofencing platform 202 determines a new virtual boundary 518 that includes a first portion 512 surrounding the current location 516 and a second portion surrounding the prior location 502. Data indicative of the new virtual boundary 518 can be sent to the content platform 206 to trigger delivery of content to mobile device(s) within the new virtual boundary 518.

In some implementations, the actively-adjusted configuration parameters include the polling interval based on which the geofencing platform 202 periodically acquires the current location of one or more movable objects 210. As described above, location polling may be associated with significant consumption of network and/or processing resources. Accordingly, in some implementations, the polling interval is adjusted, e.g., so that the geofencing platform 202 is not polling more than is necessary. For example, in some implementations, when the movable object is moving more slowly, the polling interval can be increased, because (i) the most recently-defined virtual boundary may be more likely to still be effective and/or (ii) the configuration parameters may be less likely to require adjustment, e.g., because user device density is less likely to change over a given period of time. Conversely, in some implementations, when the movable object speed increases (e.g., with other criteria and configuration parameters held equal), the polling interval can be decreased so that more up-to-date virtual boundaries are defined to reflect the faster-changing conditions of the movable object. In some implementations, the polling interval is adjusted based on mobile device density, where higher device densities correspond to lower polling intervals (e.g., to provide more up-to-date information) and lower device densities correspond to higher polling intervals.

In some implementations, the actively-adjusted configuration parameters include a shape of the virtual boundary. Using different shapes for geofences may provide improved flexibility and provision in targeting mobile devices in particular locations, e.g., when boundaries of locations are complex or irregular. In various implementations and situations, geofences may have a shape of a circle, corridor, rectangle, ellipsis, star, oval, or polygon, among other shapes. For example, in some implementations, the shape of the virtual boundary is adjusted based on a current location of the movable object. For example, the virtual boundary can be shaped to match shapes of city blocks, streets, squares/plazas, parks, public transportation routes, portions of building(s) (e.g., portions of a mall or arena as the movable object moves through the mall or arena), and/or other features. In some implementations, the virtual boundary can be shaped to match shapes of a transportation-related area, e.g., to match shapes of boarding platforms of a train or metro railcar that is a movable object. In the example of FIG. 6, based on a current location 606 of a movable object 102 navigating on a street 602, a virtual boundary 604 (which may be an entire virtual boundary or a portion of a virtual boundary) is defined to include a sidewalk 608 adjacent to the street 602, where, for example, a density of mobile devices may be highest. For example, the virtual boundary 604 can be defined at least partially based on the geometry of the street 602 and/or the sidewalk 608. This geography-aware/landmark-aware geofencing may improve efficiency, for example, by reducing network transmission to mobile devices of users in cars on the streets and/or in buildings, who may not see or otherwise interact with the movable object 102. Other examples of shape adjustment include adjusting the shape to match location(s) where an event is taking place; adjusting the shape based on a purpose of the geofence, e.g., to target users within a specific area; adjusting the shape based on the size of the virtual boundary (e.g., a smaller virtual boundary may have a more finely-tuned shape); and/or adjusting the shape based on a technology used to define the geofence and/or to poll a location of a movable object. For the latter adjustment, the shape may correspond to a shape of device locations returned by location polling. For example, GNSS-based location polling may return a circle in which the movable object is located, such that the virtual boundary may partially or wholly have a circular shape, while device location services, Wifi location detection, and/or Bluetooth location detection may provide other shapes of areas in which the movable object is located, and the virtual boundary can be shaped accordingly. Shape adjustment may including adjusting a height and/or vertical positioning of a virtual boundary, as discussed in more detail in reference to FIG. 8.

To provide several non-limiting examples, in some implementations, a circular virtual boundary, or portion of a virtual boundary, surrounds a transit stop or station, with the circle's radius being a configuration parameter as described throughout this disclosure. In some implementations, a corridor-shaped virtual boundary, or portion of a virtual boundary, surrounds a transit route, where a distance between the virtual boundary and a line of the transit route is a configuration parameter. In some implementations, a rectangular virtual boundary, or portion of a virtual boundary, surrounds a transit stop/station, e.g., a metro station or a bus stop, where a dimension (e.g., side length) of the rectangular virtual boundary is a configuration parameter. In some implementations, a polygon-shaped virtual boundary, or portion of a virtual boundary, surrounds an area along a transit route with irregular boundaries, e.g., a transit hub with multiple stops or stations. These and other transit route-based virtual boundaries can be defined based on the location of a movable object (e.g., train or bus). For example, when a train is a movable object, a virtual boundary can be defined to surround a station when the train stops at the station and shortly afterwards (the latter as a tail region).

To adjust a shape of a virtual boundary (e.g., to match a geographic feature such as a road or a portion of a building), in some implementations, the geofencing platform 202 obtains geographic data from another platform 208, such as a mapping platform that can provide map data with road dimensions and/or building data with building dimensions. The geofencing platform 202 can adjust the shape of the virtual boundary to match a shape in the geographic data.

Although FIGS. 4A-4B and 5A-5B illustrate examples of adjusting a single configuration parameter based on a single criterion, in some implementations, one or more configuration parameters can be adjusted based on multiple criteria, and/or one or more criteria can be used to adjust multiple configuration parameters. The adjustment of configuration parameters performed by the geofencing platform 202 can be a unified adjustment in which multiple configuration parameters are adjusted together, in a unified process, based on multiple criteria.

For example, in some implementations, a unified analysis is applied based at least on content distribution criteria. Content distribution criteria can relate to a campaign for which content is being distributed. For example, a campaign may involve the distribution of content to at least x1 and at most x2 mobile devices, with a goal of at least y engagements with the distributed content, with the content to be distributed over between t1 (minimum campaign length) and t2 (maximum campaign length) days; x1, x2, y, f1, and t2 are non-limiting examples of content distribution criteria. Based on one or more of these and/or other content distribution criteria, the geofencing platform 202 can identify a target mobile device number or threshold mobile device number, and the configuration parameters can be actively adjusted so that the target or threshold number of mobile devices will receive content. For example, the target/threshold device number can be associated with a pace for digital content delivery based on the content distribution criteria, where digital content is to be delivered at the pace over the course of a campaign. Too-rapid distribution of content (e.g., a consistently higher number of mobile devices receiving content, compared to the target/threshold number) may result in a campaign that ends too soon, is too costly, or has low levels of engagement for the amount of distributed content, while too-slow distribution of content (e.g., a consistently lower number of mobile devices receiving content, compared to the target/threshold number) may result in an ineffective campaign that fails to garner a desired amount of engagement within a predetermined campaign duration.

Accordingly, in some implementations, the geofencing platform 202 adjusts the configuration parameters so that approximately the target/threshold number of mobile devices are within the virtual boundary defined based on the configuration parameters. In response to the number of mobile devices being determined to be different than the target/threshold number, a shape, particular dimension, tail length, and/or polling interval of the virtual boundary can be adjusted to cause the number of mobile devices within the virtual boundary to be closer to the target/threshold number. The geofencing platform 202 can apply a cohesive analysis that takes into account real-time or near-real-time engagement data (as described above) to determine a combination of virtual boundary dimension(s), virtual boundary tail length, virtual boundary shape, and/or polling interval that are predicted to cause delivery of content to the target/threshold number of devices.

In some implementations, the target/threshold number is a target/threshold number of engagements with delivered content, and the configuration parameters are actively adjusted so that the target/threshold number of engagements are achieved. For example, the geofencing platform 202 can determine a predicted engagement efficiency (engagements per content delivered to a mobile device), and the configuration parameters can be adjusted such that the number of mobile devices in the virtual boundary times the engagement efficiency is equal to, or approximately equal to, the target/threshold number of engagements, which may be based on, for example, a pacing of engagements desired to occur over the course of the campaign. In some implementations, the geofencing platform 202 determines the engagement efficiency based on one or more of virtual boundary dimension(s) (e.g., where larger particular dimensions may be associated with lower engagement efficiency), movable object speed (e.g., where higher speeds may be associated with lower engagement efficiency), data obtained from another platform 208 (e.g., demographic data indicative of user demographics in the vicinity of the movable object, where certain demographics may be associated with higher/lower engagement efficiencies for the current campaign), and/or engagement data indicative of past engagement efficiency for the current campaign and/or other campaigns.

In some implementations, one or more digital content owners (such as a brand owner or advertising agency) uploads digital content (such as advertising) to be associated with a campaign and with one or more movable objects. For example, the digital content can be uploaded to the content platform 206 and/or the geofencing platform 202. The content platform 206 and/or the geofencing platform 202 generate, based on the digital content, dynamic content for display on the digital signage associated with one or more movable objects based on goals for the campaign and provides the dynamic content for presentation by the movable objects 210.

In some implementations, processes and systems described herein can be adapted for use with rideshare programs and/or taxis. When a user orders a rideshare vehicle, the user typically provides both a pickup location and a drop-off location. In the case of a taxi, in some cases only the drop-off location is known in advance. When the rideshare vehicle or taxi is a movable object 210 displaying content, a virtual boundary associated with the vehicle can be generated based on the pickup location and/or drop-off location. For example, the geofencing platform 202 can define a virtual boundary around the pickup location for at least some time before the vehicle reaches the pickup location (e.g., starting a predefined amount of time before, such as three minutes), and/or the geofencing platform 202 can define a virtual boundary around the drop-off location for at least some time before the vehicle reaches the drop-off location. As such, and in some cases based on a content identifier sent from the geofencing platform 202 to the content platform 206, mobile devices within the geofence can be provided with content associated with content presented by the rideshare vehicle or taxi.

In addition to, or instead of, the use of the pickup location and/or drop-off location, content can be provided to mobile devices within a virtual boundary associated with (e.g., including/surrounding) the rideshare vehicle or taxi as described for other types of movable objects 210 throughout this disclosure. The dynamic virtual boundary is adjusted around the rideshare vehicle or taxi using its real-time location and/or speed. The geofence dimensions and/or shape are adjusted dynamically as the rideshare vehicle or taxi moves around a region, in some cases based on a density of mobile devices in the region and/or live engagement data. In some implementations, digital signage displayed on the rideshare vehicle or taxi is dynamically updated based on factors like the vehicle's location, time of day, surrounding environment, and/or marketing campaign goals, e.g., by generating content and updating the digital signage on the vehicle.

In some implementations, when a mobile device within the virtual boundary accesses an application or internet content while physically present within the virtual boundary, a system (e.g., the geofencing platform 202 and/or the content platform 206) determines most relevant content to present to the mobile device and delivers the most relevant content to the mobile device. For example, a matching process to determine the most relevant content can be based on one or more factors, such as: the specific content displayed on one or more movable objects 210 in proximity to the mobile device (e.g., a movable object 210 associated with the virtual boundary, and in some cases one or more additional movable objects 210), where the specific content can in some cases be dynamically adjusted, e.g., as described with respect to the fleet content platform 216; user preferences (e.g., as provided by other platforms 208); mobile device proximity to one or more movable objects 210 presenting content (e.g., where content corresponding to content presented by a closer movable object 210 can be more relevant than content corresponding to content presented by a farther movable object 210); and/or one or more other types of data. For example, a relevance score can be generated for each of multiple content, and the content having the highest relevance score can be provided to the mobile device.

The user's interaction with the delivered content is tracked, and feedback is collected. This feedback, along with engagement data, and in some embodiments the feedback is used to fine-tune the geofence parameters, customize the content displayed on the taxi, and enhance the content distribution mechanism, among other things. The process runs in a continuous loop to optimize the content display and delivery process, ensuring that the advertising content remains relevant and engaging for users within the geofence of the taxi.

In some implementations, the geofencing platform 202 determines the configuration parameters using a trained machine learning model, e.g., a neural network. The machine learning model can receive, as inputs, the criteria described above, to obtain, as output, one or more configuration parameters. Training the machine learning model can include training a neural network by configuring parameters of connected nodes aggregated into multiple layers, such that the connected nodes perform successive transformations of input data (e.g., one or more of the criteria) to output the configuration parameters. The trained machine learning model can run on the geofencing platform 202 to automatically adjust the configuration parameters in real-time.

A machine learning model can be used to actively adjust the configuration parameters for a virtual boundary in real-time based on location data for a movable object, such as a public bus. The model can be trained on a dataset of previous location data and corresponding configuration parameters to learn patterns and relationships between the data and the parameters. For example, training the model can including adjusting weights and hyperparameters of the model based on the dataset. Using this information, the trained model can predict high-performing configuration parameters for the virtual boundary based on the current location and speed of the bus, the route and schedule of the bus, weather conditions, traffic patterns, and/or the number of mobile devices within the region. The model may instead or additionally be trained on live tracking data and data from a fleet management system (fleet platform 204), including the movable object's current location, speed, performance, and/or related records. These inputs can be used to actively adjust the configuration parameters for the virtual boundary, such as the dimensions and/or location polling interval, in real-time. The model's predictions can be used to optimize the virtual boundary for delivering content to the maximum number of mobile devices while the movable object is in motion and/or stationary.

The particular manner in which the configuration parameters are adjusted can vary across different implementations. However, in some implementations, in response to an increase (decrease) in the number of mobile devices in a region (e.g., an increase in a density of the mobile devices): particular dimension(s) (e.g., length, width, radius, or height) of the virtual boundary are decreased (increased), a tail length of the virtual boundary is decreased (increased), and/or the location polling interval is decreased (increased). In some implementations, in response to an increase (decrease) in a speed of the movable object, the particular dimension(s) of the virtual boundary are decreased (increased), the tail length of the virtual boundary is decreased (increased), and/or the location polling interval is decreased (increased). In some implementations, when a movable object is stopped (has very low or zero speed), particular dimension(s) of the geofence are decreased. In some implementations, in response to the number of mobile devices in the virtual boundary being greater than (less than) than the target/threshold number of mobile devices, particular dimension(s) of the virtual boundary are decreased (increased) and/or a tail length of the virtual boundary is decreased (increased). In some implementations, in response to the predicted number of engagements being greater than (less than) than the target/threshold number of engagements, particular dimension(s) of the virtual boundary are decreased (increased) and/or a tail length of the virtual boundary is decreased (increased). The dynamic adjustment of the configuration parameters, as described, optimizes the delivery of content to mobile devices in a region. By adapting the dimensions of the virtual boundary and the location polling interval in response to the number of mobile devices, the speed of the movable object, and the predicted number of engagements, the system can efficiently manage data transmission. This can result in improved network performance, reduced latency, and minimized network congestion, thereby providing a significant improvement over conventional geofencing methods.

As non-limiting examples, in some implementations, a particular dimension of a virtual boundary (e.g., radius, width, or length) is between 5 meters and 200 meters. In some implementations, a tail length is between five seconds and two minutes or between zero prior locations of the movable object (no tail) and twenty prior locations of the movable object. In some implementations, the location polling interval is between 0.5 seconds and two minutes.

Some additional non-limiting examples of how the dimensions of a virtual boundary can be adjusted include the following. For a virtual boundary surrounding a pedestrian, the radius of the boundary can be set to a small value (e.g., between one and ten meters, e.g., five meters) to ensure that any nearby mobile devices receive content. For a virtual boundary surrounding a car traveling on a highway, the width of the boundary can be set to a moderate value (e.g., between ten and 100 meters, e.g., 50 meters) to ensure that content is delivered to a larger number of mobile devices in the surrounding area. For a virtual boundary surrounding a train, the length of the boundary can be set to a high value (e.g., larger than 100 meters, such as 200 meters) to ensure that content is delivered to mobile devices along the entire length of the train. For a virtual boundary surrounding a boat, the tail length can be set to between one and ten seconds (e.g., five seconds) to ensure that any mobile devices that were within the virtual boundary but have since moved out of it continue to receive content for a short period of time. For a virtual boundary surrounding a bike messenger, the location polling interval can be set to a short value, such as less than two seconds (e.g., 0.5 seconds) to ensure that the virtual boundary is continuously updated based on the messenger's rapid movements. For a virtual boundary surrounding a drone, the tail length can be set to, for example, between five prior locations and thirty prior locations (e.g., twenty prior locations of the drone) to ensure that mobile devices within the virtual boundary receive content even if the drone moves quickly or erratically.

In some implementations, a virtual boundary associated with a movable object is defined in three dimensions, e.g., to have a height and vertical positioning in addition to lateral dimensions. For example, as shown in FIG. 8, a drone 802 is a movable object (having an associated virtual boundary 806) that flies near a building 804. The virtual boundary 806, having a height 808, is defined to encompass several floors of the building 804 near where the drone 802 is currently flying. As the drone 802 flies to higher/lower elevations, the virtual boundary 806 can be redefined to encompass higher/lower floors and to exclude floors that the drone 802 is no longer near (except for floors that may be included in a possible tail portion of the virtual boundary 806, not illustrated here). In this example, the virtual boundary 806 excludes a ground level 810, such that, for example, a pedestrian walking on the sidewalk near the building 804 would not receive content. In some implementations, a three-dimensional virtual boundary is defined to include the ground level. For example, a virtual boundary associated with a bus may include both the ground level (e.g., sidewalks of a street on which the bus travels) and elevated floors of buildings from which users are able to see the bus (e.g., elevated floors of buildings on the street).

The three-dimensional parameters (e.g., height) of the virtual boundary can be actively adjusted as described above and, in some implementations, based on geographic locations of the movable object. For example, a metro railcar may travel between an elevated station and an underground station. When the railcar is at the elevated station, the geofencing platform 202 polls the location of the railcar and, based on the location, defines the virtual boundary to extend above ground level to include the elevated station. When the railcar is at the underground station, the geofencing platform 202 polls the location of the railcar and, based on the location, defines an irregularly-shaped, underground virtual boundary that encompasses the underground station and stairs leading from the underground station to the streets above. The height of the virtual boundary can be adjusted to include more or fewer elevations based on the location of the movable object and/or based on other factors. For example, the height of the virtual boundary, as a particular dimension of the virtual boundary, can be adjusted based on a number of mobile devices in a region.

As described for two-dimensional geofences described above, three-dimensional geofences can have shapes adjusted to the current context of a movable object. For example, a cylinder-shaped geofence can target mobile devices in the interior of a cylindrical building or a circular park. A cone-shaped geofence can target mobile devices around the area of a mountain peak. A pyramid-shaped geofence can target mobile devices in the interior of a pyramid-shaped building. A corridor-shaped geofence can target mobile devices adjacent to a transit route, and the corridor-shaped geofence can be changed to a cylinder-shaped geofence as the location of the geofence moves into a transit station. The use of three-dimensional shapes can provide more flexibility and precision in targeting mobile devices in specific places.

In some implementations, the network and/or processing efficiency of the systems described herein can be further enhanced by the use of data batching. In a batching process, data corresponding to multiple entities is transmitted together as a combined data transmission, providing a reduction in consumed network resources. For example, in some implementations, when the geofencing platform 202 polls the fleet platform 204 to obtain locations of multiple movable objects 210, the geofencing platform obtains batched locations of the multiple movable objects 210, rather than separate data transmissions for each movable object 210. In some implementations, when the geofencing platform 202 sends multiple virtual boundaries and multiple corresponding content identifiers (e.g., for multiple campaigns and/or based on dynamic content on mobile platforms 210) to the content platform 206 to trigger delivery of content, the geofencing platform 202 provides the data as batched data, rather than sending multiple separate data transmissions corresponding to different content identifiers. By transmitting data corresponding to multiple entities together as a combined data transmission, the system can significantly reduce the network resources required for data transfer. This method of data transmission also reduces the processing load on the system, enabling faster and more efficient computation.

As noted and described in part above, in some implementations, cookie and/or pixel-based tracking can facilitate contextualized content provision in which past engagement data determines future geofence definitions and/or types of delivered content. Contextualized content provision can be performed on the level of a single user—e.g., personalized content delivery—and/or as an aggregate process.

As an example, after content distribution to a mobile device in a virtual boundary, the geofencing platform 202 receives data indicative of user engagement with the content and indicative of user engagement with a physical product associated with the campaign (e.g., from another platform 208). The data indicative of user engagement with the content can be based on a pixel on a landing page accessed by the user's mobile device when the user interacts with the content. The data indicative of user engagement with the physical product can be based on a cookie stored on the user's mobile device tracking the interaction with the physical product. Interaction with the physical product can be detected based on, for example, near field communication (NFC) interaction, Bluetooth interaction, QR code scanning, bar code scanning, RFID interaction, Wifi interaction, Zigbee interaction, URL access, image recognition, voice recognition, and/or biometric sensor recognition. One or more virtual boundaries can be updated based on this data. For example, if the geofencing platform 202 determines that a high concentration of mobile devices in a location have previously interacted with the physical product, the virtual boundary can be redefined (e.g., increased in size and/or defined in a different location) to reach new users.

As another example, a user's interaction with content delivered to a mobile device can be tracked, and data indicating the interaction can be provided to the geofencing platform 202 by another platform 208. Based on the engagement data, the geofencing platform 202 can adjust content presented by a movable object 210, e.g., by sending an instruction to the fleet content platform 216 to present particular content based on the engagement. The mobile device can be within a virtual boundary associated with the movable object 210. For example, when a user interacts with a provided advertisement, a mobile digital billboard near the user can be caused to display a responsive message noting the interaction.

As another example, the geofencing platform 202 can determine, based on engagement data, that the movable object 210 is traveling in/to an area with a high density or number of mobile devices that previously interacted with content associated with a particular campaign (based on engagement data). In response, the geofencing platform 202 can cause the movable object 210 to present content from the particular campaign by sending an instruction to the fleet content platform 216. As such, users in the virtual boundary of the movable object 210 are more likely see the content from the campaign and may be more likely to interact with associated with presented on their mobile devices based on their presence in the virtual boundary.

By these and other processes of dynamic adjustment of virtual boundaries and presented content, a continuous loop of content presentation, tracking, and responsive adjustment can optimize the content display and delivery process, ensuring that the advertising content remains relevant and engaging for users.

Some features described herein, such as the platforms 202, 204, 206, and 208, may be implemented in digital and/or analog electronic circuitry or in computer hardware, firmware, software, or in combinations of them. Some features may be implemented in a computer program product tangibly embodied in an information carrier, e.g., in a machine-readable storage device, for execution by a programmable processor.

Method steps may be performed by a programmable processor executing a program of instructions to perform functions of the described implementations by operating on input data and generating output, by discrete circuitry performing analog and/or digital circuit operations, or by a combination thereof.

Some described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java, Python, JavaScript, Swift), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A system comprising:
one or more processors; and
one or more computer-readable mediums encoding instructions that, when executed, cause the one or more processors to
receive location data for a movable object, the location data specifying geographic locations of the movable object over time,
define dimensions of a virtual boundary in real-world physical space based on the geographic locations of the movable object over time and configuration parameters for the virtual boundary,
send data indicative of the virtual boundary in real-world physical space to trigger delivery of content to mobile computing devices within the virtual boundary, and
actively adjust the configuration parameters for the virtual boundary in response to a number of the mobile computing devices within a region while continuing to receive the location data for the movable object, define the dimensions of the virtual boundary, and send the virtual boundary to trigger delivery of content.

2. The system of claim 1, wherein the virtual boundary comprises a first portion defining a region surrounding a current geographic location of the movable object, and a second portion that does not surround the current geographical location of the movable object,
wherein the configuration parameters comprise a dimension of the first portion.

3. The system of claim 2, wherein the second portion defines a tail region surrounding a prior geographic location of the movable object at a prior time,
wherein the configuration parameters define at least one of a time interval between the prior time and a current time or a distance between the prior geographic location and the current geographic location.

4. The system of claim 1, wherein the instructions, when executed, cause the one or more processors to actively adjust the configuration parameters in response to a speed of the movable object.

5. The system of claim 4, wherein the active adjustment of the configuration parameters by the one or more processors in response to the speed of the movable object comprises:
in response to a decrease in the speed of the movable object, increasing a dimension of a region bounded by the virtual boundary.

6. The system of claim 1, wherein the region comprises a region bounded by the virtual boundary.

7. The system of claim 1, wherein the active adjustment of the configuration parameters by the one or more processors in response to the number of the mobile computing devices within the region comprises:
in response to an increase in the number of the mobile computing devices within the region, decreasing a dimension of a region bounded by the virtual boundary.

8. The system of claim 1, wherein the instructions, when executed, cause the one or more processors to obtain the location data periodically in accordance with a time interval, and
wherein the active adjustment of the configuration parameters by the one or more processors in response to the number of the mobile computing devices within the virtual boundary comprises:
in response to an increase in the number of the mobile computing devices within the region, decreasing the time interval at which to send the virtual boundary to trigger delivery of content.

9. The system of claim 1, wherein the instructions, when executed, cause the one or more processors to:
receive data indicative of a number of mobile computing devices engaging with the content, and
determine the number of the mobile computing devices within the region based on the number of mobile computing devices engaging with the content.

10. The system of claim 9, wherein the data indicative of the number of mobile computing devices engaging with the content comprises a number of mobile computing devices that interact with a tracking pixel or a cookie associated with the content.

11. The system of claim 1, wherein the active adjustment of the configuration parameters by the one or more processors in response to the number of the mobile computing devices within the region comprises:
adjusting a dimension of a region bounded by the virtual boundary to cause a number of devices within the virtual boundary to match a target value.

12. The system of claim 11, wherein the instructions, when executed, cause the one or more processors to determine the target value based on one or more of:
a remaining amount of the content for distribution,
a remaining time for distribution of the content, or
user engagement with previously-distributed content.

13. The system of claim 1, wherein the instructions, when executed, cause the one or more processors to actively adjust a height of a region bounded by the virtual boundary.

14. The system of claim 13, wherein region bounded by the virtual boundary excludes a ground level in a vicinity of the movable object.

15. The system of claim 1, wherein the active adjustment of the configuration parameters by the one or more processors in response to the number of the mobile computing devices within the region comprises:
adjusting a shape of the virtual boundary to match a shape of a geographic feature.

16. The system of claim 1, wherein the instructions, when executed, cause the one or more processors to determine the number of the mobile computing devices within the region based on one or more of traffic data or weather data.

17. The system of claim 1, wherein the instructions, when executed, cause the one or more processors to actively adjust content presented by the movable object, and
wherein sending the data indicative of the virtual boundary in real-world physical space comprises sending an indicator of particular content to deliver to the mobile computing devices within the virtual boundary, wherein the particular content is associated with the content presented by the movable object.

18. The system of claim 17, wherein actively adjusting the content presented by the movable object comprises selecting the content presented by the movable object based on at least one of a location of the movable object, a current time, a surrounding environment of the movable object, or engagement data.

19. The system of claim 1, wherein sending the data indicative of the virtual boundary in real-world physical space comprises:
selecting particular content to deliver to the mobile computing devices within the virtual boundary based on dynamic content currently presented by the movable object; and sending an indicator of the particular content to trigger delivery of the particular content.

20. A method comprising:
receiving location data for a movable object, the location data specifying geographic locations of the movable object over time;
defining dimensions of a virtual boundary in real-world physical space based on the geographic locations of the movable object over time and configuration parameters for the virtual boundary;
sending data indicative of the virtual boundary in real-world physical space to trigger delivery of content to mobile computing devices within the virtual boundary; and
actively adjusting the configuration parameters for the virtual boundary in response to a number of the mobile computing devices within a region while continuing to receive the location data for the movable object, define the dimensions of the virtual boundary, and send the virtual boundary to trigger delivery of content.

21. The method of claim 20, wherein the virtual boundary comprises a first portion defining a region surrounding a current geographic location of the movable object, and a second portion that does not surround the current geographical location of the movable object,
wherein the configuration parameters comprise a dimension of the first portion.

22. The method of claim 20, wherein the method includes actively adjusting the configuration parameters in response to a speed of the movable object.

23. One or more non-transitory computer-readable mediums encoding instructions that, when executed by one or more processors, cause the one or more processors to:
receive location data for a movable object, the location data specifying geographic locations of the movable object over time,
define dimensions of a virtual boundary in real-world physical space based on the geographic locations of the movable object over time and configuration parameters for the virtual boundary,
send data indicative of the virtual boundary in real-world physical space to trigger delivery of content to mobile computing devices within the virtual boundary, and
actively adjust the configuration parameters for the virtual boundary in response to a number of the mobile computing devices within a region while continuing to receive the location data for the movable object, define the dimensions of the virtual boundary, and send the virtual boundary to trigger delivery of content.

24. (canceled)

25. (canceled)
